(19) United States
(12) Patent Application Publication
(10) Pub. No.: US 2002/0100644 A1
(43) Pub. Date: Aug. 1, 2002

(54) Mast assembly

(76) Inventor: Matthew D. Stringer, Archbold, OH (US)

Correspondence Address: EMCH, SCHAFFER, SCHAUB & PORCELLO CO, P O BOX 916, ONE SEAGATE SUITE 1980, TOLEDO, OH, 43697

(21) Appl. No.: 09/774,853

(22) Filed: Jan. 31, 2001

(51) Int. Cl. B66F 9/06; B66B 11/08

(52) U.S. Cl. 187/266; 187/230

(57) ABSTRACT

A mast section for use in a personnel lift has an interior curved section, a first opposing exterior curved section, and a second opposing exterior curved section.

### FIELD OF THE INVENTION

This invention is directed to a mast assembly and more specifically, to a collapsible mast assembly for use on personnel lifts that are manually transportable between locations and can be readily set up.

### BACKGROUND OF THE INVENTION

Personnel lifts are used for many applications. The personnel lift generally has an aerial work platform which is raised or lower to position a worker a desired height. Personnel lifts are used to gain access to overhead lighting fixtures, heating and air conditioning ducts, ceilings and the like.

The personnel lift typically includes an aerial work platform which is attached to a vertical lift or mast assembly. The vertical mast assembly includes multiple extendible sections mounted on a base. The personnel lift also includes a device to stabilize the personnel lift, and a personnel basket or cage in which the worker stands. After the personnel lift is securely stabilized, the worker enters the personnel basket and operates controls to raise and lower the aerial platform.

The worker often moves the personnel lift to several overhead locations in the course of one day. The worker must move the personnel lift from one location to another because the worker is limited to working in an area in which is within an arm's reach of the aerial platform. When the worker desires to do work beyond that reach, the worker must lower the aerial platform, exit the personnel basket, release the device stabilizing the platform, and move the personnel lift to the next desired location. The worker repeats the process of securing the personnel lift base and doing work in the next desired location.

Each of these steps is time consuming since the worker must carefully maneuver the personnel lift to a desired location, often through doorways, around overhead obstructions such as light fixtures and side obstructions such as a narrow aisleways.

In order to reach desired heights of 30 to 40 feet, the prior art personnel lifts have masts multiple sections that, even when collapsed, extend much higher than typical doorways. The personnel lift must then be tilted back or otherwise maneuvered through doorways and openings in order to be moved from one position to another.

It has been found that the personnel lift undergoes repeated raising and lowerings of the aerial platform during daily use. The repeated raising and lowering operations puts stress on the personnel lift and, in particular, on the mast assemblies. Also, uneven weight distribution on the aerial platform puts great stress on the mast assembly. Further, when the mast sections are not perfectly aligned, one side of the mast assembly receives increased pressure or wear, which greatly reduces the safety and the useful life of the personnel lift.

Yet another industry concern is that the masts are difficult to manufacture. The masts must be made within very close tolerances so that the individual mast sections slide properly relative to one another. Many prior art masts have rollers on the mast column that sit within channels of an adjacent mast column in order to move one mast column with respect to the adjacent mast column. It is difficult to keep each mast column in alignment as the columns move past each other during the raising and lowering of the mast. It is important to have the rollers fit securely within the column to prevent any swaying or movement of the masts and to prevent undesirable contact of the rollers with the mast columns.

Also, masts must support great weights, often at high elevated positions. It is also important that the mast be sturdy enough to prevent distortion or bending of the mast sections when the mast assembly is in an elevated position. Therefore, the masts are typically made of very heavy or thick materials which adds undesirable weight to the mast.

There is a need in the industry for a more efficient personnel lift assembly that is easily moved to a variety of locations.

There is a further need for an improved mast assembly which is collapsible and can be easily maneuvered through standard doorways.

There is a further need for a mast assembly that is lightweight, and yet can provide the desired strength and support for the aerial platform.

### SUMMARY OF THE INVENTION

The present invention provides a collapsible, light weight mast assembly. In accordance with the present invention, a personnel lift having a mast assembly of the present invention is described in detail. It should be understood, however, that the mast assembly of the present invention is useful for elevating different types of aerial platforms and the like and that such uses are within the contemplated scope of the present invention. However, for ease of explanation, the mast assembly of the present invention will be described in detail herein in connection with a personnel lift.

The personnel lift includes a base having center mounted wheels and a plurality of rotatable or caster wheels on the corners of the base. The base includes a stabilizing system having a plurality of outriggers attached to the base. The personnel lift includes a mast assembly operatively mounted at one end to the base and at the opposing end to an aerial platform/basket assembly. The mast assembly comprises a plurality of mast sections which are nested together when the mast is in a collapsed or closed position. The mast sections are extended in a vertical direction when the mast is in an open or raised position.

Each mast section defines a generally arcuate interior channel which allows adjacent mast sections to nest within the channel of an adjacent mast section. The configuration of each mast section allows multiple mast sections to occupy less space when the mast assembly is in a collapsed position than prior art mast assembly configurations. The efficiently collapsed mast assembly of the present invention allows the personnel lift to be easily maneuvered through doorways and below other low obstacles since the mast assembly does not extend higher than the first or initial mast section when the mast assembly is in the collapsed position.

The invention, together with the advantages thereof, may best be understood by reference to the following description taken in connection with the accompanying drawings.

### BRIEF DESCRIPTION OF THE DRAWINGS

FIG. 1 is a perspective view, partially in phantom, of a personnel lift with a mast assembly in a partially raised position.

FIG. 2 is an end view, partially in phantom, of two adjacent mast sections schematically showing the placement of certain sheaves and rollers.

FIG. 3 is a side elevational view, partially in phantom, of mast sections in a partially extended position.

### DETAILED DESCRIPTION OF THE PREFERRED EMBODIMENT

A personnel lift 10 includes a base assembly 12, a mast assembly 14 mounted to the base assembly 12, and an aerial platform/basket assembly 16 operatively connected to the mast assembly 14.

The base assembly 12 includes a base platform 20. The mast assembly 14 is preferably mounted at substantially the center of the base platform 20. The base 20 includes a pair of opposed wheels 22 and 24.

The base assembly 20 includes a plurality of stabilizing or outrigger devices 60 as described in a copending application, Serial No. 09/______, which is expressly incorporated herein by reference. In the embodiment shown, the personnel lift has four outrigger stabilizing systems, one mounted at each opposing corner of the base 20. However, it should be understood that, in certain embodiments, either fewer or more outrigger systems can be utilized to provide stability to the personnel lift.

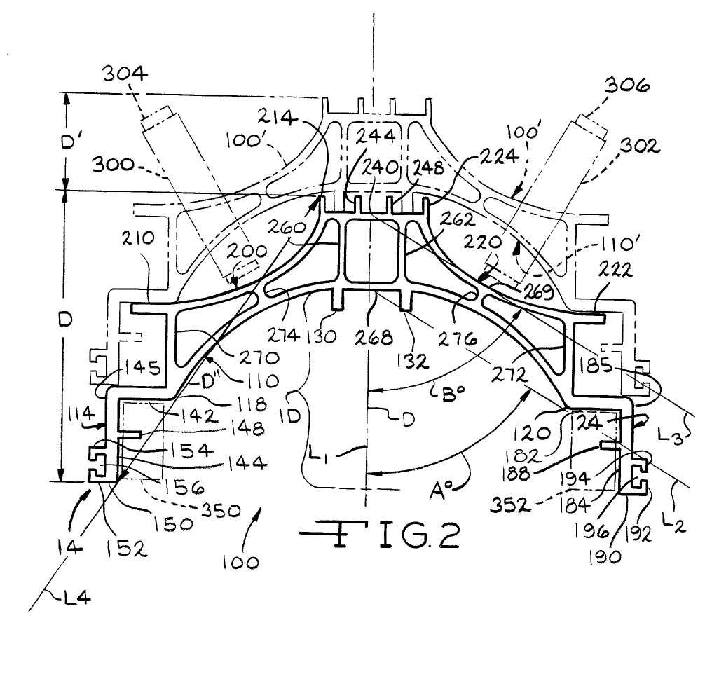

The mast assembly 14 generally comprises a plurality of individual mast sections 100 which are preferably identical in cross-section. FIG. 2 shows an end view of a mast section 100 and a phantom view of an adjacent mast section 100′. The mast section 100 generally includes a first interior curved section 110 which terminates at a first end 118 adjacent a first angled guide section 114. The interior curved section 110 terminates at a second end 120 adjacent a second angled guide section 124. The interior curved section 110 has two radially inwardly extending and spaced apart flanges 130 and 132.

The first angled guide section 114 has a first leg 142 and a second leg 144. The first and second legs 142 and 144 generally define a right angle. The first leg 142 extends in an outward direction from the first end 118 of the interior curved section 110.

The second leg 144 extends at a right angle from the first leg 142 at a first end 145. An inwardly extending flange 148 extends at a right angle from a midpoint of the second leg 144 in a direction toward the opposing angled section 124. The second leg 144 has a second end 150 which includes a pair of opposing bracket members 152 and 154 that define a first channel 156 for receiving cables (not shown).

Similarly, the second angled guide section 124 has a first leg 182 and a second leg 184. The first and second legs 182 and 184 generally define a right angle. The first leg 182 extends in an outward direction from the second end 120 of the interior curved section 110.

The second leg 184 extends at a right angle from the first leg 182 at a first end 185. An inwardly extending flange 188 extends at a right angle from a mid portion of the second leg 184 in a direction toward the opposing angle section 114. The second leg 184 has a second end 190 which includes a pair of opposing bracket members 192 and 194 that define a second channel 196 for receiving cables (not shown).

The mast section 100 has a first exterior curved section 200 and a second, opposing exterior curved section 220. The first outwardly curved section 200 and the second outwardly curved section 220 are positioned in opposite directions to the interior curved section 110. The second exterior extending curve section 220 also curves in an opposed curved direction from the curve defined by the first exterior curved section 200. The curves defined by the first exterior curved section 200 and the second exterior curved section 220 are symmetrically positioned on the mast section 100 such the first exterior curved section 200 and the second exterior curved section 220 are equidistant from each other and the first exterior curved section 200 is a “mirror image” of the second opposing exterior curved section 220.

The first exterior curved section 200 has a first end 210 which is in opposed and parallel relationship to the first leg 142 of the first angled section 114. The exterior curved section 200 terminates at a distal or second end 214. Similarly, the second exterior curved section 220 has a first end 222 which is in an opposed and parallel relationship to the first leg 182 of the second angled section 124. The second exterior curved section 220 terminates at a distal or second end 224.

A support member 240 extends from the second end 214 of the first curved exterior section 200 to the second end 224 of the second exterior curved section 220. The support member 240 defines a first outwardly extending flange 244 and a second opposed outwardly extending flange 248. The first and second outwardly extending flanges 244 and 248 of the support section 240 are in an opposed and parallel relationship to the second end 214 and the second end 224 of the first and second exterior curved sections 200 and 220, respectively. At least one or more internal support members 260 and 264 extend between the support member 240 and a midpoint 268 of the interior curved section 110.

An internal support member 270 extends from a point adjacent the first end 210 of the first exterior curved section 200 in a direction toward the first end 118 of the interior curved section 110. Another internal support member 272 extends from a point adjacent the first end 222 of the second exterior curved section 220 in a direction toward the second end 120 of the interior curved section 110. Still further support members 274 and 276 extends from midpoints of the first and second exterior curved sections 200 and 210, respectively, in a direction toward the interior curved section 110.

It should be understood that fewer or more internal support members 272, 274 and/or 276 can extend between the interior curved section 110 and the exterior curved sections 200 and/or 220, and that such other numbers of internal support sections, which provide support and rigidity to the mast section 100, are within the contemplated scope of the present invention.

The interior curved section 110 defines an interior arcuate surface that is substantially symmetrical about the midpoint 268. The interior arcuate surface of the interior curved section 110 has an Angle A° that is defined by a first line drawn L₁ through the midpoint 268 and substantially the center of the support 240 and a second line L₂ drawn through the midpoint 268 and the second end 120 of the interior curved section 110. In the embodiment shown in FIG. 2, the angle A° is preferably between about 60° to about 70°, and most preferably about 65°.

Each exterior curved section 200 and 220 defines an exterior arcuate surface that is at an angle B° with respect to the first line L₁ and a third line L₃ drawn through substantially a center point of the support 240 of the mast section 100 and a center point 269 on the exterior curved section 220. In the embodiment shown in FIG. 2, the angle B° is preferably between about 55° to about 65°, and most preferably about 60°.

It is to be understood that the interior arcuate surface of the interior curved section 110 can have a generally semicircular internal circumference (not shown) or, alternatively, can have a generally parabolic shape, as generally shown in FIG. 2. The exterior arcuate surface of the exterior curved sections 200 and/or 220 can have an asymmetrical curved shape, as shown in FIG. 2, to readily accept different shaped rollers (not shown) and/or guiding cables (not shown). It is to be further understood that various configurations of the arcuate surfaces of the interior curved section 110 and the exterior curved sections 200 and 210 are useful and as such are within the contemplated scope of the present invention.

The mast assembly 14 thus comprises a plurality of individual mast sections 100 that are nested together such that the exterior curved sections 200 and 220 of the first mast section 100 are adjacent the interior curved section 110′ of the adjacent mast section 100′. The depth, D, of each mast section 100 allows each adjacent mast section 100′ to be efficiently nested together. When the mast assembly 14, which is comprised of a plurality of adjacent mast sections 100, 100′ and so on, is in a retracted or collapsed position, no mast section extends beyond the height of the first mast section 100. The deep nesting of the individual mast sections allows many mast sections to be incorporated in a compact area on the personnel lift 10. In a preferred aspect, each mast section can have a height of about 6 to about 7 feet such that the personnel lift can be easily maneuvered through standard doorways and under low hanging obstacles. Since many mast sections can be nested together without extending the height of the personnel lift beyond the height of the first mast section, it is possible to provide an easily maneuverable personnel lift that can easily reach extended heights of 30 to 60 feet.

The mast section 100 defines a deep cross-sectional area, or exterior depth, D, from the first and second ends 150 and 190, respectively, of the first and second angled sections 114 and 124, respectively, to the outwardly extending flanges 244 and/or 248 of the exterior curved sections 200 and/or 220. This depth, as shown by the line generally designated at D, allows multiple mast sections to be stacked or nested adjacent each other in an efficient manner.

This deep nesting of the adjacent mast sections allows the mast assembly to contain many mast sections in a relatively narrow horizontal space. As shown in FIG. 2, the adjacent mast section 100′, shown in phantom, extends beyond the first mast section 100 for a depth generally defined as D′, while the first mast section 100 generally extends to a depth of D. In a preferred aspect, the depth, D, of the first mast section 100 is about 70 to about 75% of the depth, D+D, of the first mast section 100 and the second mast section 100. That is, the ratio of depth D to the combined depth D+D′ is about 0.70 to about 0.8, and most preferably about 0.74 to about 0.76, as generally shown in the following equation:

D/(D+D′)=about 0.70 to about 0.80.

Further the interior depth, ID, of the mast section 100 is about 65% to about 75% of the depth, D, of the exterior depth of the mast section 100. That is, the ratio of the interior depth ID to the exterior depth, D, is about 0.65 to about 0.75, and most preferably about 0.69 to about 0.71, as generally shown in the following equation:

ID/D=about 0.65 to about 0.75.

The depth of the interior curved section 110 allows many mast sections to be efficiently nested together in a small amount of space.

The cross-sectioned area or depth, D, provides mast section 100 with increased strength and resistance to stresses. It is to be noted that the stress on the mast section is determined by distance, D″, between the mast section's outermost points; i.e., as shown in FIG. 2, the distance, D″, shown by a fourth line L₄, between the first bracket member 152 and the second end 214 of the first curved exterior section 200 and similarly, while not shown with a line, the distance between the second bracket member 190 and the second end 224 of the second curved exterior section 220. Thus, in a preferred aspect, the ratio of the length D″ to the Depth, D (i.e., D″/D) is preferably from about 1.25 to about 1.5, and in the most preferred aspect is about 1.27 to about 1.29.

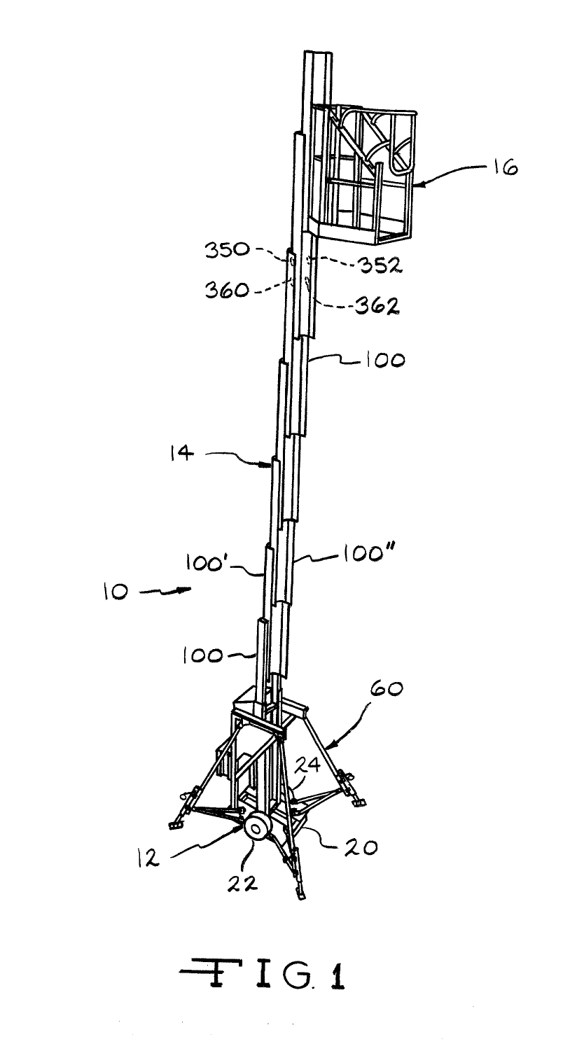

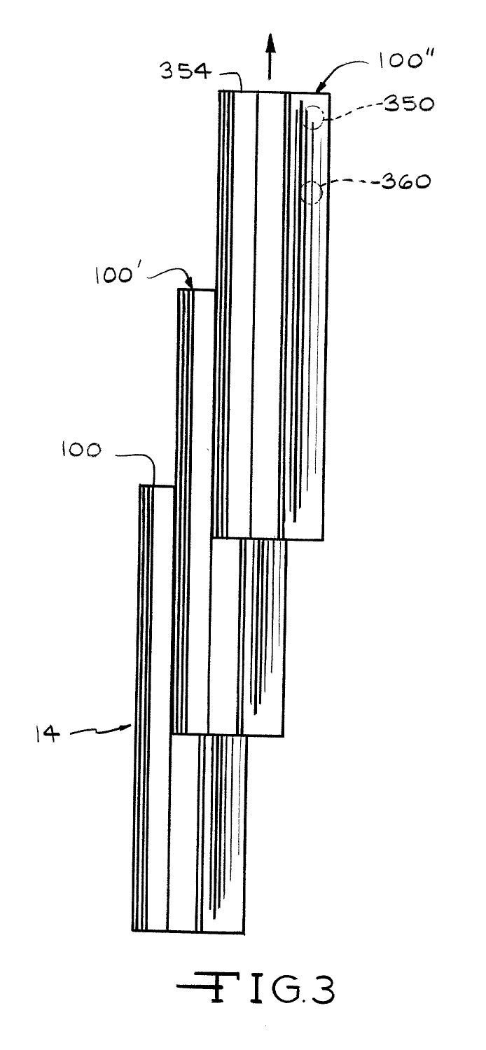

FIG. 2 shows in phantom the placement of a pair of sheaves 300 and 302 and chains 304 and 306 on each sheave, respectively, relative to the second curved exterior sections 200 and 220 of the mast section 100. The mast section 100 allows the sheaves 300 and 302 and chains 304 and 306, respectively, to be mounted at a generally perpendicular angle with respect to the third line L₃. The angled position of the sheaves 300 and 302 and the chains 304 and 306 further allows the adjacent mast sections 100 and 100′ to be nested together in an efficient manner. It is to be understood that, while not shown, the sheaves and the chains mounted on each sheave are operatively mounted on a suitable bracket member (not shown) which is operatively mounted on the mast section such that the movement of each adjacent mast section occurs in a desired manner. In a preferred aspect, as the mast assembly is being extended to a raised or elevated position, each of the extendable mast sections simultaneously moves in an upward direction, until such time that the- mast assembly is raised to its desired height. Thus, FIG. 1 and FIG. 3 show the partially extended mast assembly 14 in which each mast section, 100, 100′ and 100″ simultaneously moves in the direction of the arrows. As best seen in FIG. 1, when the mast assembly 14 is raised to its desired height, but not in a fully extended position, one adjacent mast section overlaps, or is positioned adjacent a defined length of the next mast section. That is, the top portion of mast section 100 overlaps the bottom portion of the adjacent mast section 100′. The overlapping of mast sections provides the mast assembly 14 with increased stability and lessens any tendency for the mast assembly 14 to tilt or lean when in the partially or fully extended position.

FIG. 3 generally shows a schematic view of multiple mast sections 100, 100′, 100″ in a nesting and partially extended relationship. The first mast section 100′ is nested or positioned within at least 70%, and preferably about 75%, of an adjacent mast section 100′. The strength and resistance to twisting and/or flexion of the mast section 100 is further enhanced by the placement of a plurality of guide rollers 350, 352, 360 and 362 on the mast section 100. A pair of opposing upper rollers 350 and 352 are mounted adjacent a first or top end 354 of the mast section. A pair of opposing or lower spaced apart rollers 360 and 362 are mounted in a spaced apart relationship to the top end 354 of the mast section.

Referring again to FIG. 2, the pair of opposed upper rollers 350 and 352 are shown in position relative to the mast section 100. The first upper roller 350 is adjacent the first angled guide section 114 while the second upper roller 352 is adjacent the second angled guide section 124. FIG. 3 shows in phantom the relative position of the upper rollers 350 and 352 and the spaced apart lower rollers 360 and 362.

The spaced apart lower rollers 360 and 362 are positioned on the mast section 100 at a distance which is about ¼ to about ⅓ of the distance from the upper rollers 350 and 352 of the mast section 100. The relatively close position of the lower rollers 360 and 362 to the top 354 of the mast section 100 further decreases any undesirable twist or flexion of the mast section.

Although the present invention has been described with respect to its preferred embodiments, those skilled in the art will recognize changes which may be made in the aforementioned structure which do not depart from the spirit of the invention already described in the specification and embodied in the following claims.

I claim:

1. A mast section comprising an interior curved section, a first opposing exterior curved section, and a second opposing exterior curved section.

2. The mast section of claim 1, wherein the interior curved section defines a first depth, ID, and wherein at least one exterior curved section and the interior curved section define a second depth, D, such that ID/D ranges from about 0.65 to about 0.75.

3. The mast section of claim 2, wherein a third depth, D+D′, is defined by the mast section and an adjacently positioned mast section, such that D/D+D′ ranges from about 0.70 to about 0.80.

4. The mast section of claim 1, wherein a first line L₁ drawn through a midpoint of the interior curved section and a second line L₂ drawn through the midpoint and an end point of the interior curved section define an angle A° that ranges from about 60° to about 70°.

5. The mast section of claim 4, wherein the first line L₁ and a third line L₃ drawn through the midpoint and a center point on the exterior curved surface define an angle B° that ranges from about 55° to about 65°.

6. The mast section of claim 1, wherein a first angled guide section extends from a first end of the interior curved section and a second angled guide section extends from a second end of the interior curved section.

7. The mast section of claim 6, wherein the first angled guide section and a distal end of the first exterior arcuate section define a third depth, D″, such that D″/D ranges from about 1.25 to about 1.5.

8. The mast section of claim 1, wherein at least one support member extends between the interior curved section and the first exterior curved section and the second exterior curved section.

9. The mast section of claim 1 further including at least one upper roller operatively mounted adjacent a top end of the mast section and at least one lower roller operatively mounted at a distance of about ¼ to about ⅓ of the length of the mast section from the top end of the mast section.

10. The mast section of claim 1 wherein the first and second exterior curved sections have the same shape.

11. A mast assembly comprising a plurality of mast sections of claim 1.

12. The mast assembly of claim 11, wherein at least one sheave is positioned adjacent at least the first exterior curved section in a generally perpendicular relationship to a line L₃ which is defined by a center point of the mast section and a center point on the exterior curved section of the mast section.

13. The mast assembly of claim 11, wherein each of the mast sections has a defined height and wherein each mast section does not substantially extend beyond the height of a first mast section when the mast assembly is in a retracted position.

14. The mast assembly of claim 13, wherein a top section of one mast section is adjacent and overlaps a bottom section of the adjacent mast section when the mast assembly is in a partially extended position.

15. The mast assembly of claim 10, wherein each mast section has a height ranging from about 6 feet to about 7 feet.

16. A personnel lift comprising at least one mast section comprising an interior curved section, a first opposing exterior arcuate section, and a second opposing exterior arcuate section.

17. The personnel lift of claim 16, wherein the interior curved section defines a first depth, ID, and wherein at least one exterior curved section and the interior curved section define a second depth, D, such that ID/D ranges from about 0.65 to about 0.75.

18. The personnel lift of claim 17, wherein a third depth, D+D′, is defined by the mast section and an adjacently positioned mast section, such that D/D+D′ ranges from about 0.70 to about 0.80.

19. The personnel lift of claim 17, wherein a first line L₁ drawn through a midpoint of the interior curved section and a second line L₂ drawn through the midpoint and an end point of the interior curved section define an angle A° that ranges from about 60° to about 70°.

20. The personnel lift of claim 19, wherein the first line L₁ and a third line L₂ drawn through the midpoint and a center point on the exterior curved surface define an angle B° that ranges from about 55° to about 65°.

21. The personnel lift of claim 16, wherein a first angled guide section extends from a first end of the interior curved section and a second angled guide section extends from a second end of the interior curved section.

22. The personnel lift of claim 21, wherein the first angled guide section and a distal end of the first exterior arcuate section define a third depth D″, such that D″/D ranges from about 1.25 to about 1.5.

23. The personnel lift of claim 16, wherein at least one support member extends between the interior curved section and the first exterior curved section and the second exterior curved section.

24. The mast section of claim 16 further including at least one upper roller operatively mounted adjacent a top end of the mast section and at least one lower roller operatively mounted at a distance of about ¼ to about ⅓ of the length of the mast section from the top end of the mast section.

25. The mast section of claim 16 wherein the first and second exterior curved sections have the same shape.

26. The mast assembly of claim 25, wherein at least one sheave is positioned adjacent at least the first exterior curved section in a generally perpendicular relationship to a line L₃ which is defined by a center point of the mast section and a center point on the exterior curved section of the mast section.

27. The personnel lift of claim 16, wherein each of the mast sections has a defined height and wherein each mast section does not substantially extend beyond the height of a first mast section when the mast assembly is in a retracted position.

28. The mast assembly of claim 27, wherein a top section of one mast section is adjacent and overlaps a bottom section of the adjacent mast section when the mast assembly is in a partially extended position.

29. The personnel lift of claim 21, wherein each mast section ranging from a height of about 6 to about 7 feet.
